(19) United States
(12) Patent Application Publication
(10) Pub. No.: US 2018/0050551 A1
(43) Pub. Date: Feb. 22, 2018

(54) COMPOSITES AND OBJECTS WITH CUSTOMIZED FABRIC PRINTING

(71) Applicant: BENJ&SOTO, Sint-Niklaas (BE)

(72) Inventor: Marie-Julie GARCIA SOTO, Amsterdam (NL)

(73) Assignee: BENJ&SOTO, Sint-Niklaas (BE)

(21) Appl. No.: 15/503,355

(22) PCT Filed: Aug. 12, 2015
(86) PCT No.: PCT/EP2015/068595

§ 371 Date: Feb. 10, 2017

(30) Foreign Application Priority Data
Aug. 12, 2014 (EP) 14180615.8

(51) Int. Cl. B41M 5/52; B32B 7/12; B32B 5/02; B32B 5/26

(52) U.S. Cl. CPC B41M 5/5254; B32B 2471/02; B32B 5/026; B32B 5/26; B32B 5/024; B32B 5/022; B41M 5/5209; B32B 2307/4023; B32B 2307/5825; B32B 2307/554; B32B 2601/00; B32B 2255/02; B32B 2607/02; B32B 2307/51; B32B 2255/06; B32B 2262/0261; B32B 2307/3065; B32B 2262/0276; B32B 7/12

(57) ABSTRACT

The invention relates to a composite comprising a base layer, preferably made of plastic foam, wood, plaster, plywood, cork, cardboard, metals or alloys, cement, concrete, stone, ceramics, glass, acrylic polymer, alumina trihydrate; an adhesive layer or a fabric layer, said layer positioned onto the base layer; one or more recurring set of layers, said set of layers comprising an adhesive layer and a fabric layer, wherein the one or more recurring set of layers are positioned onto the adhesive layer or fabric layer, in an alternate order; provided that the composite comprises at least 3 layers in addition to the base layer. In one embodiment, the base layer is an object or surface covered with the described layers.

### FIELD OF THE INVENTION

The present invention relates to the field of composites, furniture, and image and printing methods on materials.

### BACKGROUND OF THE INVENTION

Protecting surfaces with a textile cover is well known, for example in the field of furniture. An example thereof may be mattresses and seats. Most of these covers need to be engineered to have certain properties specific to the end purpose. As such, a cover of a surface normally exists out of many different pieces that are stitched together.

Surface covers are made with different techniques. With some of these techniques it is possible to create surfaces seamlessly. This is for instance the case of spray coating or flocking by which, chemicals, fibres or a mix thereof are sprayed onto a surface. This spraying is performed until a full, seamless coverage of the surface is achieved. Although these techniques are widely used, they lack the capability of creating images or visual patterns onto said surfaces. Due to the limiting properties of the materials that are used to spray, it is not feasible to subsequently print a surface with a durable image.

High temperature imaging methods are printing methods that use a high temperature to create an image onto a surface. Common examples include transfer printing and sublimation printing. These techniques are used to print colours and images on textile substrates.

Sublimation transfer printing is usually carried out on man-made fabrics, in particular polyester based fabrics. Sublimation transfer printing is performed by printing an image in sublimation dye onto a paper carrier or substrate. The image may be formed for instance by digital printing onto the paper carrier. In order to do the transfer of the image onto the fabric, the face of the carrier which bears the image is placed against the fabric surface. Pressure is then applied at an elevated temperature, for instance by means of a heated press. This causes the dye on the substrate to sublimate, and this gas impregnates the fabric fibres, where the dye solidifies.

EP0351085A2 discloses sublimation transfer printing onto a fabric substrate made by natural fibres, with the use of an acrylic binder, containing for example n-butyl methacrylate.

EP1375733 discloses another sublimation transfer printing onto a multi-component fabric made of multiple types of fibres. The receptive side in contact with the carrier is made out of a synthetic fibre, typically a polyester fibre. The non-receptive side of the woven fabric can be any material.

U.S. Pat. No. 6,387,479 discloses a reparation method employing a reinforcing anisotropic fabric, for example a polyester fabric to repair or reinforce a pre-existing structure such as a building. A fabric is combined with a resin to repair a damaged area.

U.S. Pat. No. 4,892,501 discloses the use of knitted polyester which is attached to a foamed polyurethane/polyester by means of an acrylic adhesive. This is then heated and pressure moulded into a first portion of a doll's head. A second portion is also formed by a similar method. The two portions are sewn to each other. The knitted polyester are coloured by a sublimation printing process. This is done before the polyester is attached onto the foamed polyurethane.

US 2011/0091690 A1 discloses a composite optical film, comprising a substrate, a releasing layer, an ink layer, and an adhesive layer. The substrate is made of polyurethane and the ink layer comprises a sublimation ink.

WO 2014/024161 A2 discloses a method for producing a duplicate of an object. The duplicate produced is composed of a hardened material made of polyurethane wherein the duplicate has a decorative surface. The decorative surface is produced with sublimation ink.

U.S. Pat. No. 6,775,937 B2 discloses a wrap-around advertising surface comprising an outer layer made of polyurethane wherein the outer layer has a printed image. The printed image is applied to the outer layer by sublimation printing. The advertising surface also comprises an adhesive layer for adhering the outer layer to other layers.

US 2010/227132 discloses a multilayer laminate comprising a base layer, an adhesive layer, and a fabric layer, wherein the base layer is made of polyurethane. The above laminate also includes a decorative layer and a varnish layer.

WO 2008/131811 A1 discloses a method for the production of a planar, printable semi-finished product, wherein a printable, unprinted printing paper layer is pressed under the influence of pressure and heat together with a planar base body.

US 2009/0280290 A1 discloses an appliqué comprising a stretchable fabric layer with an image. The first surface to the fabric layer is bonded to polyurethane and the second surface contains sublimation dye.

The above-mentioned techniques however do not disclose a seamless covering of a surface that can be printed onto and which can have different degrees of flexibility or hardness to accommodate all kinds of applications.

It is an objective of the present invention to provide a non-stitched or seamless finishing, and allowing stretching over difficult objects, such as a cube, with a seamless finishing.

It is another objective of the present invention to provide a coating that can withstand wear and tear.

It is another objective of the present invention to provide a durable composite, object or structure, that is tear-resistant, and that does not sand or peel.

It is a further objective of this invention to provide a composite, object or structure that is puncture resistant.

It is another objective of the present invention to provide a composite, object or structure that is non-flammable and fire resistant.

It is an aim of the present invention to provide a composite supporting an personalized image, that does not deform or loses its colour, and whose ink has a UV filter, therefore being resistant to outside sun exposure.

It is another aim of the present invention to provide a printed composite whose colour withstands rubbing.

The present invention further aims to provide a flexible object or structure that may be used as protective cloth, clothing item, or carpet.

The present invention further aims at providing more rigid objects or structures, that may be a wall coverage, tiles, or common furniture.

It is another objective of the present invention to provide a structure with more rigid corners and edges that may be less easily deformed.

### SUMMARY OF THE INVENTION

The present invention relates to a composite comprising a) a base layer; b) optionally an adhesive layer or a fabric layer, said adhesive or fabric layer positioned onto the base layer; c) one or more recurring set of layers, said set of layers comprising an adhesive layer and a fabric layer, wherein the one or more recurring set of layers are positioned, in an alternate order, onto the base layer (a) or onto the optional (b) adhesive layer or fabric layer; d) optionally a protective finish applied onto at least a portion of the one set of layers (c), or onto the last set of the recurring set of layers (c); provided that the composite comprises at least 3 layers in addition to the base layer.

The present invention relates to a composite comprising a) a base layer; b) an adhesive layer or a fabric layer; c) one or more recurring set of layers, said set of layers comprising an adhesive layer and a fabric layer, wherein the one or more recurring set of layers are positioned, in an alternate order, onto the (b) adhesive layer or fabric layer; and wherein the base layer (a) is impregnated with said b) adhesive layer or wherein the base layer (a) is covered partly, substantially, or fully with said b) fabric layer.

The present invention also relates to an object or a surface comprising the referred composite.

The present invention further relates to a method for seamlessly covering an object comprising the steps of: a) providing an object; b) optionally applying an adhesive layer or a fabric layer, onto at least one portion of the object; c) applying one or more recurring set of layers, said set of layers comprising an adhesive layer and a fabric layer, wherein the one or more recurring set of layers are positioned, in an alternate order, onto the object or onto the optional (b) adhesive layer or fabric layer; d) optionally applying a protective finish onto at least one portion of the one set of layers (c), or onto the last set of the recurring set of layers (c); provided that the composite comprises at least 3 layers in addition to the base layer.

The present invention further relates to a method for seamlessly covering an object or surface comprising the steps of: a) providing an object or surface; b) impregnating at least one portion of the object or surface with an adhesive layer or covering at least one portion of the object or surface with a fabric layer; c) applying one or more recurring set of layers, said set of layers comprising an adhesive layer and a fabric layer, wherein the one or more recurring set of layers are positioned, in an alternate order, onto the (b) adhesive layer or fabric layer.

The invention will be further elucidated by means of the following description.

### DETAILED DESCRIPTION OF THE INVENTION

The present invention relates to a composite comprising a) a base layer; b) optionally an adhesive layer or a fabric layer, said adhesive or fabric layer positioned onto the base layer; c) one or more recurring set of layers, said set of layers comprising an adhesive layer and a fabric layer, wherein the one or more recurring set of layers are positioned, in an alternate order, onto the base layer (a) or onto the optional (b) adhesive layer or fabric layer; d) optionally a protective finish applied onto at least a portion of the one set of layers (c), or onto the last set of the recurring set of layers (c); provided that the composite comprises at least 3 layers in addition to the base layer.

The present invention relates to a composite comprising a) a base layer; b) an adhesive layer or a fabric layer; c) one or more recurring set of layers, said set of layers comprising an adhesive layer and a fabric layer, wherein the one or more recurring set of layers are positioned, in an alternate order, onto the (b) adhesive layer or fabric layer; and wherein the base layer (a) is impregnated with said b) adhesive layer or wherein the base layer (a) is covered partly, substantially, or fully with said b) fabric layer.

The present invention relates to a composite according to any one of the embodiments presented herein, wherein in the one or more recurring set of layers (c), any one of the fabric layers are impregnated with the adhesive layer.

The present invention relates to a composite according to any one of the embodiments presented herein, wherein any one of the adhesive layer are cured.

The present invention relates to a composite according to any one of the embodiments presented herein, wherein the composite further comprises an image applied onto the one set of layers (c), or onto the last set of the recurring set of layers (c).

The present invention relates to a composite according to any one of the embodiments presented herein, wherein the adhesive layer comprises pigments.

The present invention relates to a composite according to any one of the embodiments presented herein, wherein the fabric layer of the last set of the recurring set of layers (c) comprises an image.

The present invention relates to a composite according to any one of the embodiments presented herein, wherein the base layer is made from but not limited to; plastic, plastic foam, wood, plaster, plywood, cork, cardboard, metals or alloys, cement, concrete, stone, ceramics, glass, silicone, acrylic polymer, alumina trihydrate, and any combination thereof.

The present invention relates to a composite according to any one of the embodiments presented herein, wherein the plastic foam is a polyurethane foam.

The present invention relates to a composite according to any one of the embodiments presented herein, wherein any one of the fabric layers is at least partially stretched.

The present invention relates to a composite according to any one of the embodiments presented herein, wherein the protective finish comprises an acrylic resin and a varnish.

The present invention relates to a composite according to any one of the embodiments presented herein, wherein the adhesive layer comprises an acrylic resin.

The present invention relates to a composite according to any one of the embodiments presented herein, wherein the protective finish comprises an hydrophobic initiating chemical.

The present invention relates to a composite according to any one of the embodiments presented herein, wherein the fabric of the fabric layer is selected from a knitted, woven, or nonwoven fabric; from a polyester, polyamide, natural or synthetic rubbers or fibers, and any mixture thereof.

The present invention relates to a composite according to any one of the embodiments presented herein, wherein the fabric of the fabric layer is selected from a knitted fabric.

The present invention relates to a composite according to any one of the embodiments presented herein, wherein the knitted fabric of the fabric layer is made from natural or synthetic fibers, in particular from cotton or Nylon®, polyester or polyamide fibers, and any mixture thereof.

The present invention relates to an object or a surface comprising the composite according to any one of the embodiments presented herein.

The present invention relates to an object or surface according to any one of the embodiments presented herein, wherein the base layer represents a substantial part of the volume of the object.

The present invention relates to an object or surface according to any one of the embodiments presented herein, wherein the adhesive or fabric layer (b) is positioned covering at least partially the base layer.

The present invention relates to an object or surface according to any one of the embodiments presented herein, wherein said object or surface is seamless to the human eye.

The present invention relates to an object or surface according to any one of the embodiments presented herein, wherein said object or surface is a decorative, utilitarian, isolating, or a protective object or surface.

The present invention relates to an object or surface according to any one of the embodiments presented herein, wherein said decorative, utilitarian, isolating, or protective object is furniture, a pouf, a sofa, a chair, a closet, a rug, a carpet for in- or out-doors, and the like.

The present invention relates to an object or surface according to any one of the embodiments presented herein, wherein said decorative, utilitarian, isolating, or protective surface is a wall or a part thereof, a panel, a tile, a brick, a slab, a floor tile, or the like.

The present invention relates to a method for seamlessly covering an object comprising the steps of: a) providing an object; b) optionally applying an adhesive layer or a fabric layer, onto at least one portion of the object; c) applying one or more recurring set of layers, said set of layers comprising an adhesive layer and a fabric layer, wherein the one or more recurring set of layers are positioned, in an alternate order, onto the object or onto the optional (b) adhesive layer or fabric layer; d) optionally applying a protective finish onto at least one portion of the one set of layers (c), or onto the last set of the recurring set of layers (c); provided that the composite comprises at least 3 layers in addition to the base layer.

The present invention relates to a method for covering a surface comprising the steps of: a) providing a surface; b) optionally applying an adhesive layer or a fabric layer, onto at least one portion of the surface; c) applying one or more recurring set of layers, said set of layers comprising an adhesive layer and a fabric layer, wherein the one or more recurring set of layers are positioned, in an alternate order, onto the surface or onto the optional (b) adhesive layer or fabric layer; d) optionally applying a protective finish onto at least one portion of the one set of layers (c), or onto the last set of the recurring set of layers (c); provided that the composite comprises at least 3 layers in addition to the surface.

The present invention further relates to a method for seamlessly covering an object or surface comprising the steps of: a) providing an object or surface; b) impregnating at least one portion of the object or surface with an adhesive layer or covering at least one portion of the object or surface with a fabric layer; c) applying one or more recurring set of layers, said set of layers comprising an adhesive layer and a fabric layer, wherein the one or more recurring set of layers are positioned, in an alternate order, onto the (b) adhesive layer or fabric layer.

The present invention relates to a method according to any one of the embodiments presented herein, wherein an image is further applied onto the one set of layers (c), or onto the last set of the recurring set of layers (c).

The present invention relates to a method according to any one of the embodiments presented herein, wherein the object or surface is made from but not limited to: plastic foam, wood, plaster, plywood, cork, cardboard, metals or alloys, cement, concrete, stone, ceramics, glass, acrylic polymer, alumina trihydrate, and any combination thereof.

The present invention relates to a method according to any one of the embodiments presented herein, wherein any one of the fabric layers is at least partially stretched.

The present invention relates to a method according to any one of the embodiments presented herein, wherein the image is applied by sublimation transfer printing.

The present invention relates to the use of the composite, the object or surface according to any one of the embodiments presented herein, as a re-enforcing means.

The present invention relates to the use of the composite, the object or surface according to any one of the embodiments presented herein, as, without being limited to, furniture or as outside furniture, a wall, tiles, clothes.

The present invention relates to the use of the composite, the object or surface according to any one of the embodiments presented herein, as a fire resistant material.

The term “composite” refers to materials made from two or more constituent materials with significantly different physical or chemical properties, that when combined, produce a material with characteristics different from the individual components.

The term “base layer” is meant to include any support or platform, and is usually made of a material suitable for providing this desired function. In particular, the “base layer” is made from a sufficiently stiff material.

The term “plastic” refers to any of a wide range of synthetic or semi-synthetic that are mouldable. Plastic materials may be, without being limited to, organic polymers, such as polyvinyl chloride (PVC), polyethylene (PE), polypropylene (PP), polyethylene terephthalate (PET), polyamide a.k.a. nylon, and the like. Plastic materials also include copolymers such as poly (methyl methacrylate), thermosets, bioplastics (made from renewable plant materials such as cellulose and starch), as well as rubbers.

The term “plastic foam” refers to a more specific plastic that is a polymeric foam, and includes, but is not limited to, polyurethane foam, polyvinyl chloride foam, polystyrene, polyimide foam, or silicone foam.

As mentioned above, the plastic foam is preferably a polyurethane foam.

The term “plaster” is defined as material manufactured as a dry powder and is mixed with water to form a paste when used. The reaction with water liberates heat through crystallization and the hydrated plaster then hardens.

The term “plywood” refers to a manufactured wood panel from the family of manufactured boards made from thin sheets of wood veneer. Plywood layers may be glued together, with adjacent plies having their wood grain rotated relative to adjacent layers up to 90 degrees.

Ceramic refers to an inorganic, nonmetallic solid prepared by the action of heat and subsequent cooling. Ceramic materials may have a crystalline or partly crystalline structure, or may be amorphous (e.g., a glass).

Cement is defined herein as a substance that sets and hardens as it dries, often used to make objects adhere to each other. It is made of a powder of, without being limited to, alumina, silica, lime, iron oxide, and magnesium oxide or any mixture thereof burned together in a kiln and finely pulverized, mixed with water.

The term “concrete” refers to a composite material composed of coarse granular material, called aggregate, cement, and water.

Cork refers to an impermeable, buoyant material, a prime-subset of bark tissue that is harvested for commercial use primarily from Quercus suber.

Cardboard is defined as a generic term for a heavy-duty paper of various strengths, ranging from a simple arrangement of a single thick sheet of paper to complex configurations featuring multiple corrugated and uncorrugated layers.

The term “adhesive layer” refers to a layer of substance that may be applied on the surface of materials, that binds the substance to the material and resists separation. A particular adhesive layer may be a coating resin, for example, but not limited to, epoxy polyester resins, vinyl resins, polyester resins, polyamide resins, polyurethane resins, acrylic resins or methacrylates, or any other thermoplastic resins or mixtures of thermoplastic resins, or an other hardening material selected from the group comprising gypsum, silicone and silicone rubbers, or any combinations thereof. A more particular adhesive layer may be polyurethane resins, acrylic resins or methacrylates, or any other thermoplastic resins or mixtures of thermoplastic resins, or any other hardening material or any combinations thereof. In an embodiment of the present invention, the adhesive layer may consist of a combination of at least two components. One of these two components is a binder, which can be polyurethane, polyester, phenolic, vinyl, epoxy or acrylic based. Preferably the binder is acrylic based. The second component that is present is a thinner, such as, but not limited to methylacetate, methoxyacetate, white spirit, xylene, toluene, alcohols, ketones, ethers, nafta or water or a mixture of the above thinners. Preferably xylene is used as a thinner. Furthermore, in order to improve various properties, it is possible to add a variety of additives, for example, but not limited to plasticizers, weathering agents, anti-static agents, lubricants, pigments, anti-foaming agents, UV stabilizers and various types of fillers. In particular, in order to create a base colour, pigments are used. The pigments used can be anything from, but not limited to titanium dioxide, zinc oxide, zinc chromate, iron oxide, organic pigments and inorganic pigments. In another embodiment of the present invention, the adhesive layer is then cured at a temperature comprised between 15 and 120° C., preferably between 40 and 90° C. This curing is done in an oven or another means of heating, for a time period comprised between 30 minutes and 10 hours, preferably between 30 minutes and 2 hours, or any sufficient time until the adhesive layer is fully cured.

The term “fabric layer” refers to a fabric that is used to fully, substantially, or partly cover the base layer, object, or surface according to the invention. In one embodiment, said fabric has a basis weight within the range of 10 to 1000 g/m², preferably within the range of 10 to 500 g/m², more preferably within the range of 10 to 300 g/m². The fabric layer may act as a qualitative receptor for the sublimation transfer print. The fabric may be made out of natural or man-made fibres, or a combination of both. The term “man-made fibres” refers to fibres obtained by a manufacturing process, as distinct from natural fibres which occur naturally in fibrous form. The fabric is selected from, and without being limited to, a knitted, woven, or nonwoven fabric; from a polyester, polyamide, natural or synthetic rubbers and fibers, and any mixture thereof. In particular, the fabric is a knitted fabric made from natural or synthetic fibers, in particular from cotton or Nylon®, polyester or polyamide fibers, and any mixture thereof.

Preferably polyester fibres are used or mixtures with other fibres where polyester is the main component. More preferably a mixture of polyester and a stretchable fabric is used. Most preferably a mixture of polyester and elastane fibres (a.k.a. lycra®) is used, wherein polyester is the main component.

Preferably polyamide fibres are used or mixtures with other fibres where polyamide is the main component.

Knitted fabric consists of consecutive rows of loops, called stitches. Each stitch is produced by pulling a new loop through and existing loop. These loops can easily be stretched into different directions, giving the knitted cloth its elastic properties. Hence knitting is used for fabrics that need to be stretched. Weft knitting and warp knitting are two major types of knitting, with the weft knitting being more common. In weft knitting, the loops are perpendicular to the course set by the yarn, while in warp knitting the loops run parallel to the course. In weft knitting, a same yarn can be used to create the entire fabric, while in warp knitting a different yarn is required for every loop. Although knitting may be done with ribbons, metal wire or more exotic filaments, most yarns are made by spinning fibers. The spun fibers are generally divided into animal fibers, plant and synthetic fibers. These fiber types are chemically different, corresponding to proteins, carbohydrates and synthetic polymers, respectively. Animal fibers include, but are not limited to silk, long hairs of animals such as sheep (wool), goat (angora, or cashmere goat), rabbit (angora), llama, alpaca, dog, cat, camel, yak, and muskox. Plants used for fibers include but are not limited to cotton, flax, bamboo, ramie, hemp, jute, nettle, raffia, yucca, coconut husk, banana trees, soy and corn. Rayon and acetate fibers are also produced from cellulose mainly derived from trees. Common synthetic fibers include but are not limited to acrylics, polyesters such as dacron and ingeo, nylon and other polyamides, and olefins such as polypropylene. Knitted fabrics include, but are not limited to, stockinette stitch, reverse stockinette stitch, garter stitch, seed stitch, faggoting, cross stitch, tuck stitch, and tricot.

The term “woven fabric” refers to a fabric produced by interlacing two different sets of yarn or threads horizontally or vertically. The vertical threads are called as warp, while the horizontal treads are known as weft or filling. The method by which the threads are woven affects the characteristics of the cloth. Weaving is usually done on a loom, either machine or hand. The loom is used to hold the warp threads in place while weft threads are woven through them. The way the threads are interlaced is known as the weave. Patterns and other designs can also be woven on the cloth. Woven threads are much more polished compared to knitted threads. They run mainly in one direction and hence are not elastic unless lycra, elastic or spandex fibers are woven into the fabric. Linen, denim, cotton twill, satin, chiffon, corduroy, tweed and canvas are examples of woven fabrics. Thread that is used in weaving is much thinner, producing lighter garments. The thread or yarn used in woven fabrics may be selected from, without being limited to, cotton, silk, flax, hemp, jute, or any other natural fiber, polyester, cellulose acetate, glass fiber cloth, carbon fibers, polyamide, elastane, polyethylene, polypropylene, polyacrylate, aramid and all possible mixtures of the above fibres.

The term “nonwoven fabric” refers to fabric-like material made from long fibers that are neither woven nor knitted, bonded together by chemical, mechanical, heat or solvent treatment. Nonwoven fabrics are not made by weaving or knitting and do not require converting the fibres to yarn. They are flat or tufted porous sheets that are made directly from separate fibres, molten plastic or plastic film. Examples may be selected from, but are not limited to felt, boiled wool, open cell foam, closed cell foam, polyurethane, neoprene and any other kinds of synthetic rubbers, paper, cardboard, and all possible mixtures thereof.

The “degree of stretch” of the at least partially stretchable fabric layer according to the invention may be calculated as follows. The degree of stretch extension may be calculated at a specific load of e.g. 250 g for sample fabrics in the four orientations of course, wale and bias (45° and 135°). The sample fabrics are then cut into strips (for ex. measuring 5 cm×20 cm) in the course, wale and bias orientation. Benchmarks are applied on 10 cm centers between which the extended length is measured. A fold of for example 2.5 cm at both ends of the strip is machined, thereby forming slots ready for the insertion of the hanger supports. In the quad load test procedure, fabric samples in the course, wale, 45° bias and 135° bias are placed on the hanger and the 250 g weight is applied. After allowing one minute for the fabric to stabilize, the extended measurement between the benchmarks is recorded.

The degree of stretch expressed as a percentage is calculated by subtracting the relaxed length from the extended length and then dividing the result by the original length, or simply by subtracting 10 cm (100 mm), from the extended length (Degree of stretch=[Extended length (mm)−100]%). Stretch results preferably show a breakdown of fabric extension into course, wale and bias (45° and 135°), which can be used to calculate the relative stretch reduction factor (Indian Journal of Fibre & Textile Research, Vol. 36, December 2011, pp. 366-379).

Alternatively, the Instron tensile testing machine is used extensively to electronically calculate the extensibility of a variety of sample materials. Several standards (BS 4952:1992; BS EN 14704-1:2005; ASTM D 4964-96:1996) highlight a number of specific tests for quality assurance (QA) and quality control (QC) for stretch fabric.

It should be noted that stretch fabrics are usually either 2-way stretch or 4-way stretch. 2-way stretch fabrics stretch in one direction, usually from selvedge to selvedge (but can be in other directions depending on the knit). 4-way stretch fabrics, such as spandex, stretches in both directions, crosswise and lengthwise.

For covering an object or a surface according to the invention, stretch fabrics are constructed by using a pattern cut to dimensions smaller than the actual shape it has to fit. Grosso modo, all length measurements are reduced by 20-25% of their total length, however these values are not limiting for the purposes of the present invention. Furthermore, the degree of stretch is dependent on the intrinsic qualities of the specific fabric. Whereas 100% spun polyester is capable of stretching between 25% and 40% in two perpendicular directions, spandex fabric are capable of stretching up to 1000%. In one embodiment, the degree of stretch of the fabric constituting the fabric layers of the present invention is, in at least one direction selected from course, bias 45°, wale 90°, and bias 135°, between 5 and 80%, more preferably between 5 and 60%, even more preferably between 10 and 40%.

A line that is “seamless to the human eye” is defined as a line that the eye will not be able to detect. The smallest objects the naked human eye is usually able to detect are objects such as a human hair. It is known that the human eye is incapable of detecting objects with a size (e.g. diameter or maximum possible width) below 40 μm.

The term “protective finish” is defined as a layer applied on top of the fabric layer, with the purpose of protecting and/or giving specific properties such as UV protection or visual effects such as gloss or matte to the structure. Examples of protective finish may be varnish, optical films, or glass.

The term “acrylic resin” refers to any one of the plastics or resin generated through chemical reaction by applying polymerization initiator and heat to a monomer. Examples may be selected from polymethyl acrylate, polymethyl methacrylate, n-butyl methacrylate, polyurethane acrylate, epoxy acrylate, polyester acrylate, siloxane acrylate, glycidyl acrylate, and all possible mixtures of the above fibres.

The term “varnish” refers to a transparent, hard, protective finish or film primarily used in wood finishing but also for other materials. Varnish is traditionally a combination of a drying oil, a resin, and a thinner or solvent. Varnish finishes are usually glossy but may be designed to produce satin or semi-gloss sheens by the addition of agents. Varnish has little or no color, is transparent, and has no added pigment.

The term “hydrophobic chemical” includes, but is not limited to, perfluorate compounds such as perfluoroalkyl and perfluoropolyether.

Applying an image onto the one set of layers, or onto the last set of the recurring set of layers may be performed by different techniques including, but not limited to, printing or thermo-printing with sublimation inks, screen printing, direct printing, printing by application, discharge printing, reserve printing (both chemical and physical), offset printing, rotogravure, digital plotter, inkjet printing, laser printing, serigraphy, flocking.

The term “outside furniture” refers to furniture specifically designed for an outdoor use, and therefore designed to resist to wear caused by an outdoor extensive use and typically made of weather-resistant materials such as teak or treated wood, wicker, plastic, aluminium, or wrought iron. Examples of outside furniture may be seats, chairs, tables, long chairs, parasol stands, plant stands and planter boxes and trellises.

The term “reinforcing means” refers to a material added in order to strengthen something for support. Examples of suitable reinforcing means include, but are not limited to, fiber-reinforced thermoset polymers made from woven or non-woven fibers impregnated in a thermoset or thermoplastic polymer resin matrix, plywood, cardboard, and cork. In one embodiment of the present invention, in order to increase the strength of the reinforcing means, more recurring set of layers are added in the composite, or onto the object or surface of the invention, said set of layers comprising an adhesive layer and a fabric layer.

The term “fire-resistant material” refers to a material having fire separating and/or load-bearing functions under fire exposure. Fire resistancy may be quantified using specified fire resistance ratings based on fire resistance tests. These ratings, expressed in minutes and hours, describe the time duration for which a given building component or system maintains specific functions while exposed to a specific simulated fire event. Various test protocols describe the procedures to evaluate the performance of for instance doors, windows, walls, floors, beams, or columns. Fire resistant materials may contain a suitable flame retardant additives. Suitable flame retardant additives include, but are not limited to, aluminium trihydrate, magnesium hydroxide, organophosphates, red phosphorous, phosphorous compounds, zinc borate, boric acid, oxides of boron, melamines, melamine derivatives, ammonium polyphosphate, ammonium pentaborate, mixture of zinc salts of alkali metals containing nanoclay, and mixtures thereof.

In an embodiment of the present invention, a base layer (or object or surface) is first impregnated with an adhesive layer. The adhesive layer is then cured, and part of the resulting composite is covered partly, substantially, or fully by a fabric layer, which is optionally conveniently stretched. A second adhesive layer, which can either have the same or a different composition as the first adhesive layer, is then applied onto the fabric, and cured as well. The step of applying alternate layers of adhesive and fabric layer is repeated as many times as desired depending on whether the object or surface is substantially or fully covered, or depending on whether the required degree of stiffness or suppleness is obtained, or any other suitable factor.

Alternatively, in another embodiment, the base layer is firstly covered partly, substantially, or fully with a fabric layer. Said fabric layer is optionally conveniently stretched. Then said fabric layer is impregnated, partly, substantially, or fully, with an adhesive layer. The adhesive layer is cured and the resulting composite. A second fabric layer, which can either have the same or different composition as the first fabric layer, is then applied onto the adhesive layer. The step of applying alternate layers of fabric and adhesive layer is repeated as many times as desired depending on whether the object or surface is substantially or fully covered, or depending on whether the required degree of stiffness or suppleness is obtained, or any other suitable factor

This method has the advantage that the base layer, object, or surface, is seamlessly covered. Also, the adhesive layer has in a cured form the capability to act as a receptor for a high temperature image process, such as sublimation transfer printing. Sublimation transfer print has the main advantage to be a durable technique, that may provide a good colour retention of the image on the chosen structure and a continuous-tone technology allowing the printing of personalized images.

In a further embodiment of the present invention, the base layer can be provided in a stiff material, such as wood, metal or alloys, plastic material, plastic foam, plaster, plywood, cork, cardboard, cement, concrete, stone, ceramic, glass, silicone, acrylic polymer, alumina trihydrate and any possible combination thereof.

Alternatively, the base layer can be made of a flexible material, such as cloth, paper, non woven fabric, polyurethane, or the like. In this case, the adhesive layer is preferably a mixture of gypsum and at least one acrylic or vinyl resin. In an exemplary embodiment, the adhesive layer may be a polyurethane resin.

In another embodiment of the present invention, the composite structure may further include one or more decorative layers to enhance the aesthetics of the surface. This or these layers may be disposed between the base layer and the protective finish. Options for creating a more aesthetic structure may include, but are not limited to: the addition of pigments to, for example, the adhesive layer, adding an additional layer of print material between an adhesive layer and a fabric layer, printing at least a side of one or more of the fabric layer, or any combination thereof.

In another embodiment of the present invention, the one or more decorative layers may be an inked image or shape including, but not limited to alpha-numeric characters, logos or images.

In a further embodiment of the present invention, the fabric layer may be a stretch material further comprising a knit or woven fabric incorporating at least 3% spandex thread in combination with other natural and/or synthetic fiber threads such as, but not limited to cotton or Nylon®, to provide a minimum degree of stretch of 5%.

In another embodiment of the present invention, the surface layer of stretch fabric may have an embossed surface, that provides surface configuration to the composite, object or surface.

In another embodiment of the present invention, the image applied onto the one set of layers or onto the last set of recurring layers may be customized.

In another embodiment of the present invention, the fabric layer may already have a pattern or an image before being used in the composite according to the present invention.

In a further embodiment of the present invention, the corners and edges of the objects according to the invention are made more rigid by covering the object with a recurring combination of an adhesive and a fabric layer, that keeps the fabric closely glued to said structure. These recurring steps ensure that the edges are less easily deformed during the further use of said object. Preferably, it is more advantageous to apply the fabric layer onto an object which has been impregnated with an adhesive layer. The impregnation can be achieved using different methods, such as, but not limited to, spray coating, dip coating, roll coating, foulard coating and extrusion coating. Preferably the adhesive layer is applied onto the base layer, object, or surface with a paint roller.

The result of this process is a composite, object or surface visually seamlessly covered by an impregnated textile cover, that may be ready to be printed in order to create a visual image using any printing or graphic technique known in the art suitable for placing graphic designs on the composite, object or surface. For example, sublimation printing utilizing heat and pressure to affix pre-printed graphics may produce a highly durable and accurate graphic. The sublimation ink may be pre-treated with UV inhibitors to prevent fading. Luminescent inks can also be used, in order to provide a glow in a dark environment. Puff inks may also be used to produce a textured surface. In addition, pastisol inks can be used in a heat transfer application for durable, long-lasting images. Wet ink printing can also be used, as well as computer generated digital graphics, which may be directly printed on various materials.

The sublimation transfer printing can be done by silk screening the sublimation dye or by first printing the sublimation inks in the desired pattern or image onto a transfer paper and in a consecutive step transferring this image onto the said cover. Preferably, the latter method is used to increase the customisation capabilities of the process.

Transferring the image may be done by a hot press. The pressing is done with a temperature between 160 and 250° C. Preferably the pressing is done with a temperature between 180 and 220° C. In order to have a durable image, the time of the pressing step may be between 10 seconds and 10 minutes. Preferably the time of the pressing is between 30 seconds and 5 minutes.

In another embodiment of the present invention, the composite, object or surface is covered by an optical film, enabling the generation of glossy gradient effects, partially glossy effects, or partially foggy effects. The optical film may be included in the protective finish. In an embodiment of the present invention, the composite structure may be used as a surface for advertising means, such as a wrap-around advertising surface.

### EXAMPLE

In this example, a foam cube measuring 40 by 40 by 48 cm was used. The foam cube was made of a polyurethane foam which had a density of 40 kg/m³.

The adhesive layer used in this specific example was composed out of 55 parts acrylic binder, Bayhydrol XP 2809, 20 parts of xylene, 20 parts of water, 2 parts of titanium dioxide and 3 parts of ethanol.

The knitted fabric used in this specific example was a knit which consisted out of a 90/10 mixture of polyester and elastane fibres, respectively. The knit was made using a cross tuck stitch and had a basis weight of 55 g/m².

In this specific example, the foam cube was first impregnated on all sides except the bottom with the adhesive composition by using a paint roller.

After this impregnation, the cube was dried during one hour in an oven at 60° C. and 60% relative humidity. In a second step, the above-described polyester-elastane knit fabric was applied on four sides of the cube. The same adhesive composition was applied onto the polyester-elastane knit fabric with a paint roller. After this impregnation, the cube was dried during one hour in an oven at 60° C. and 60% relative humidity. After these steps, a polyester-elastane knit fabric was used again to cover the remaining sides of the cube that were not yet covered before. This knit was the same knit as the one used in the previous step. Finally, the same adhesive composition as above was applied onto the new polyester-elastane knit fabric layer with a paint roller. After this impregnation, the cube was dried during one hour in an oven at 60° C. and 60% relative humidity.

The resulting cube was subsequently printed by sublimation transfer using digitally printed images onto transfer paper. The selected sides of the cube were made in contact each with a specific transfer paper and a hot press. The press was heated to a temperature of 180° C. The press time was of 4 minutes. As a result, the cube had a coloured image on all the six sides and was apparently seamlessly printed and manufactured.

To the resulting cube, a protective finish comprising an acrylic resin and a varnish was applied.

The resulting cube with images was thoroughly tested. The images on the cube were tested according to ISO 105-B02 with a Xenotest 220+Atlas. A bluescale of 7 categories was used. After the test, the images on the cube showed to have a colour fastness level of 6, which is sufficient to pass the test for indoor conditions.

The quality of the resistance of the images on the cube was tested according to ISO 12947-2, quantifying abrasion resistance by the Martindale method. A standard wool fabric was used to perform the rubbing cycles. After 200.000 rounds of Martindale, the surface of the cube was still unharmed, thus demonstrating the excellent adhesion between the adhesive layer and the polyester-elastane knit.

1. A composite comprising
a) a base layer;
b) an adhesive layer or a fabric layer,
c) one or more recurring set of layers, said set of layers comprising an adhesive layer and a fabric layer, wherein the one or more recurring set of layers are positioned, in an alternate order, onto the (b) adhesive layer or fabric layer; and
wherein the base layer (a) is impregnated with said b) adhesive layer or wherein the base layer (a) is covered partly, substantially, or fully with said b) fabric layer;
wherein in the one or more recurring set of layers (c), any one of the fabric layers are impregnated with the adhesive layer.

2. (canceled)

3. The composite according to claim 1, wherein any one of the adhesive layers are cured.

4. The composite according to claim 1, wherein the fabrics in any one of the fabric layers are, independently of each other, selected from a knitted fabric.

5. The composite according to claim 4, wherein the knitted fabric is made from natural and/or synthetic fibers, preferably from cotton or Nylon®, polyester or polyamide fibers, and any mixture thereof.

6. The composite according to claim 1, wherein the composite further comprises d) a protective finish applied onto at least a portion of the one set of layers c), or onto the last set of the recurring set of layers c).

7. The composite according to claim 6, wherein the protective finish comprises an acrylic resin and a varnish.

8. The composite according to claim 1, wherein the composite further comprises an image applied onto the one set of layers (c), or onto the last set of the recurring set of layers (c).

9. The composite according to claim 1, wherein the fabric layer of the last set of the recurring set of layers (c) comprises an image.

10. The composite according to claim 1, wherein the adhesive layer comprises an acrylic resin.

11. (canceled)

12. The composite according to claim 1, wherein the base layer is made from plastic, plastic foam, wood, plaster, plywood, cork, cardboard, metals or alloys, cement, concrete, stone, ceramics, glass, silicone, acrylic polymer, alumina trihydrate, and any combination thereof.

13. (canceled)

14. An object or a surface comprising the composite according to claim 1.

15. The object or surface according to claim 14, wherein said object or surface is seamless to the human eye.

16. The object or surface according to claim 14, wherein said object or surface is a decorative, utilitarian, isolating, or a protective object or surface.

17. The object or surface according to claim 16, wherein said decorative, utilitarian, isolating, or protective object is furniture, a pouf, a sofa, a chair, a closet, a rug, or a carpet for in- or out-doors.

18. The object or surface according to claim 16, wherein said decorative, utilitarian, isolating, or protective surface is a wall or a part thereof, a panel, a tile, a brick, a slab, or a floor tile.

19. A method for seamlessly covering an object or surface comprising the steps of:
a) providing an object or surface;
b) impregnating at least one portion of the object or surface with an adhesive layer or covering at least one portion of the object or surface with a fabric layer,
c) applying one or more recurring set of layers, said set of layers comprising an adhesive layer and a fabric layer, wherein the one or more recurring set of layers are positioned, in an alternate order, onto the (b) adhesive layer or fabric layer, and impregnating any one of the fabric layers partly, substantially, or fully with the adhesive layer,
thereby forming an object or a surface according to claim 14.

20. The method according to claim 19 further comprising the step d) of applying a protective finish onto at least one portion of the one set of layers c), or onto the last set of the recurring set of layers c).

21. The method according to claim 19 further comprising the step of applying an image onto the one set of layers c), or onto the last set of the recurring set of layers c).

22. The method according to claim 21, wherein the image is applied by sublimation transfer printing.

23. The method according to claim 19, comprising the steps of:
a) providing an object or surface;
b) impregnating at least one portion of the object or surface with a first adhesive layer wherein said first adhesive layer is subsequently cured,
c) covering partly, substantially, or fully the cured adhesive layer, as formed in step b), with a fabric layer, wherein said fabric layer is then further impregnated with a second adhesive layer, being equal to or different from the first adhesive layer, followed by curing said second adhesive layer.

24. The method according to claim 23, wherein step c) of applying alternating layers of fabric and adhesive layer is repeated as many times so as to obtain a seamlessly covered object or surface.

25. The method according to claim 19, comprising the steps of:
a) providing an object or surface;
b) covering partly, substantially, or fully at least one portion of the object or surface with a first fabric layer;
c) impregnating said fabric layer partly, substantially, or fully, with an adhesive layer wherein said adhesive layer is subsequently cured, subsequently a second fabric layer, being equal to or different from the first fabric layer, is applied onto said cured adhesive layer.

26. The method according to claim 25, wherein step c) of applying alternating layers of adhesive and fabric layer is repeated as many times so as to obtain a seamlessly covered object or surface.

27. The method according to claim 19, wherein the object or surface is made from plastic foam, wood, plaster, plywood, cork, cardboard, metals or alloys, cement, concrete, stone, ceramics, glass, acrylic polymer, alumina trihydrate, and any combination thereof.

28. (canceled)

29. (canceled)

30. The method according to claim 19, wherein the fabrics in any one of the fabric layers are, independently of each other, selected from a knitted fabric.

31. The composite according to claim 30, wherein the knitted fabric is made from natural and/or synthetic fibers, preferably from cotton or Nylon®, polyester or polyamide fibers, and any mixture thereof.

32. (canceled)
